(19) United States
(12) Patent Application Publication
(10) Pub. No.: US 2021/0115988 A1
(43) Pub. Date: Apr. 22, 2021

(54) LAUNCH CONTROL TRANSMISSION BRAKE

(71) Applicant: Sean Madden, Simsboro, LA (US)

(72) Inventor: Sean Madden, Simsboro, LA (US)

(21) Appl. No.: 17/078,065

(22) Filed: Oct. 22, 2020

Related U.S. Application Data
(60) Provisional application No. 62/924,192, filed on Oct. 22, 2019.

(51) Int. Cl. F16D 48/06; B60W 30/18

(52) U.S. Cl. CPC F16D 48/066; B60W 30/18027; F16D 2500/10412; F16D 2500/3024; F16D 2500/31453; F16D 2500/31433; F16D 2500/31413; F16D 2500/1082

(57) ABSTRACT

The presently disclosed invention is related to methods to launch and a launch control transmission brake comprising a block, an input port and an output port defined in the block, a fluid path connecting the input port and the output port, an electrically actuated valve along the fluid flow path that closes the fluid path when the electrically actuated valve is actuated, an input path being the flow path between the input port and the electrically actuated valve, an output path being the flow path between the output port and the electrically actuated valve, and an actuator that actuate the electrically actuated valve.

### CROSS REFERENCE TO RELATED APPLICATIONS/PRIORITY

The present invention claims priority to U.S. Provisional Patent Application No. 62/924,192, filed Oct. 22, 2019, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

Launching a standard transmission vehicle quickly off the line, demands much dexterity and risks damage to the vehicle if performed incorrectly. Previous attempts to address this issue have been ineffective, and yet drag racers are still risking thousands of dollars of damage to their drive train with contemporary launching.

### SUMMARY

Wherefore, it is an object of the present invention to overcome the above-mentioned shortcomings and drawbacks associated with the current technology. The present invention is directed to methods and apparatuses that satisfy the above shortcomings and drawbacks. The methods and apparatus comprise a launch control transmission brake.

The presently disclosed invention also relates to methods of launching a preferably manual transmission vehicle, such as an automobile, a car, a truck, a pickup truck, for example, using a launch control transmission brake as described herein.

The presently disclosed invention also relates to a vehicle including a launch control transmission brake as described herein.

The presently disclosed invention is related to methods to launch and a launch control transmission brake comprising a block, an input port and an output port defined in the block, a fluid path connecting the input port and the output port, an electrically actuated valve along the fluid flow path that closes the fluid path when the electrically actuated valve is actuated, an input path being the flow path between the input port and the electrically actuated valve, an output path being the flow path between the output port and the electrically actuated valve, and an actuator that actuate the electrically actuated valve. According to a further embodiment the launch control transmission brake of further comprises a pressure sensor path leading from a pressure sensor port defined in the block to the input path, and a pressure sensor mounted on the pressure sensor port. According to a further embodiment the launch control transmission brake further comprises a clutch bleeder path leading from a clutch bleeder port defined in the block to the output path, and a clutch bleeder valve mounted on the clutch bleeder port. According to a further embodiment the launch control transmission brake further comprises an Electronic Control Unit (ECU) that is electrically connected to the electrically actuated valve and actuates and de-actuates the electrically actuated valve to achieve proper launch control transmission brake performance. According to a further embodiment the launch control transmission brake further comprises a communication module electrically connected to the ECU that can receive wireless communications. According to a further embodiment the launch control transmission brake further comprises a monitor electrically connected to the ECU that displays a status of the launch control transmission brake functioning, and receives a user's instruction. According to a further embodiment the ECU has instructions stored on an ECU memory, the instructions when executed by a processor of the ECU causes the processor to: in a first step, actuate the electrically actuated valve and close the fluid flow path when a vehicle the launch control transmission brake is installed in is at a standstill and a clutch disc is slip-engaged with a flywheel, locking the clutch disc in a current state of engagement with the flywheel, and in a second step, un-actuate the electrically actuated valve to a degree that allows the fluid flow path to partially open, and causing the clutch disc to move into further engagement with they flywheel. According to a further embodiment the instructions stored on the ECU memory when executed by the processor of the ECU further causes processor to, in a third step, fully un-actuate the electrically actuated valve when the clutch disc becomes fully engaged with the flywheel, where engagement is a function of one of comparative rotational speeds of the flywheel and the clutch disc and torque transfer between the flywheel and the clutch. According to a further embodiment the ECU initiates the first step in response to a signal from one of display mounted to the vehicle and a mobile device.

The presently disclosed invention is also related to methods to launch and a launch control transmission brake comprising a block, an input port and an output port defined in the block, a fluid path connecting the input port and the output port defined in the block, an input electrically actuated valve along an input path of the fluid flow path, an output electrically actuated valve along an output path of fluid flow path between the input electrically actuated valve and the output port, and a needle valve along a flow control path of the fluid flow path, the flow control path connecting at a first end where the input path meets the output path, and connecting at a second end to the output path between the output electrically actuated valve and the output port. According to a further embodiment the launch control transmission brake further comprises an input electrical harness electrically connecting the input electrically actuated valve to power and a first actuator; and an output electrical harness electrically connecting the output electrically actuated valve to power and a second actuator. According to a further embodiment the launch control transmission brake further comprises hydraulic tubing connecting the input port to a master cylinder, and additional hydraulic tubing connecting the output port to a slave cylinder. According to a further embodiment the first actuator is one of a button and a switch mounted on one of a steering wheel, a dashboard and stick shift, and the second actuator is one of a button and a switch mounted on one of the steering wheel, the dashboard and the stick shift. According to a further embodiment the first and the second actuator not both mounted on a same one of the steering wheel, the dashboard and the stick shift, and the stick shift. According to a further embodiment the launch control transmission brake further comprises a relay electrically connected to the input electrical harness. According to a further embodiment the input electrically actuated valve and the output electrically actuated valve are both 2-way normally open solenoid cartridge valves. According to a further embodiment the input electrically actuated valve is a normally open spool type cartage solenoid. According to a further embodiment the launch control transmission brake further comprises a pressure sensor path leading from a pressure sensor port defined in the block to the input path, and a pressure sensor mounted on the pressure sensor port, and a clutch bleeder path leading from a clutch bleeder port defined in the block to the output path, and a clutch bleeder valve mounted on the clutch bleeder port. According to a further embodiment the launch control transmission brake further comprises an Electronic Control Unit (ECU) that is electrically connected to the input electrical harness and the output electrical harness, a communication module electrically connected to the ECU that can send and receive wireless communications, wherein the ECU has instructions stored on an ECU memory, the instructions when executed by a processor of the ECU causes the processor to in a first step, actuate the output electrically actuated valve and close the output path when a vehicle in which the launch control transmission brake is installed in is at a standstill, in a second step, when a clutch disc is moved to be slip-engaged with a flywheel, actuating the input electrically actuated valve, locking the clutch disc in a current state of engagement with the flywheel, in a third step, when the user first, fully releases a brake pedal that was depressed more than 25% of a brake pedal path, and second, depresses a gas pedal more than 50% of a gas pedal path, fully un-actuate the input electrically actuated valve, causing the clutch disc to move into further engagement with they flywheel at a controlled rate, and in a fourth step, when the user then depresses a clutch pedal more than 5% of a clutch pedal path, fully un-actuate the output electrically actuated valve.

The presently disclosed invention is further related to methods to launch and a launch control transmission brake comprising a block, an input port and an output port defined in the block, a fluid path connecting the input port and the output port defined in the block, an input electrically actuated valve along an input path of the fluid flow path, an output electrically actuated valve along an output path of fluid flow path between the input electrically actuated valve and the output port, a needle valve along a flow control path of the fluid flow path, the flow control path connecting at a first end where the input path meets the output path, and connecting at a second end to the output path between the output electrically actuated valve and the output port, an input electrical harness electrically connecting the input electrically actuated valve to power and a first actuator, an output electrical harness electrically connecting the output electrically actuated valve to power and a second actuator, hydraulic tubing connecting the input port to a master cylinder, and additional hydraulic tubing connecting the output port to a slave cylinder, the first actuator being one of a button and a switch mounted on one of a steering wheel, a dashboard and stick shift, the second actuator being one of a button and a switch mounted on one of the steering wheel, the dashboard and the stick shift, the first and the second actuator not both mounted on a same one of the steering wheel, the dashboard and the stick shift, and the stick shift, a relay electrically connected to the input electrical harness, the input electrically actuated valve and the output electrically actuated valve are both 2-way normally open solenoid cartridge valves, a pressure sensor path leading from a pressure sensor port defined in the block to the input path, and a pressure sensor mounted on the pressure sensor port, and a clutch bleeder path leading from a clutch bleeder port defined in the block to the output path, and a clutch bleeder valve mounted on the clutch bleeder port.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that while the accompanying drawings are to scale for at least one embodiment, the emphasis is instead placed on illustrating the principles of the invention. The invention will now be described, by way of example, with reference to the accompanying drawings in which:

FIG. 1 is front plan view of two directional valve embodiment of a launch control transmission brake according to the disclosed invention, the electrical harnesses are show in this Fig., but not in FIGS. 2-5 for clarity's sake;

FIG. 2 is a top plan view of the launch control transmission brake in FIG. 1;

FIG. 3 is a bottom view of the launch control transmission brake in FIG. 1;

FIG. 4 is a left-side view of the launch control transmission brake in FIG. 1;

FIG. 5 is a right-side view of the launch control transmission brake in FIG. 1;

FIG. 6 is a hydraulic diagram of fluid flow through the block of the launch control transmission brake in FIG. 1;

FIG. 7 is a schematic representation of a vehicle with the launch control transmission brake in FIG. 1 installed therein;

FIG. 8 is a schematic representation of a vehicle with a one directional valve embodiment of the launch control transmission brake according to the disclosed invention being installed therein, and a hydraulic diagram of fluid flow through the block is additionally shown;

FIG. 9 is left-side plan view of the launch control transmission brake in FIG. 8;

FIG. 10 is a right-side plan view of the launch control transmission brake in FIG. 8;

FIG. 11 is a front plan view of the launch control transmission brake in FIG. 8;

FIG. 12 is a rear plan view of the launch control transmission brake in FIG. 8;

FIG. 13 is a top plan view of the launch control transmission brake in FIG. 8; and

FIG. 14 is a bottom view of the launch control transmission brake in FIG. 8;

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

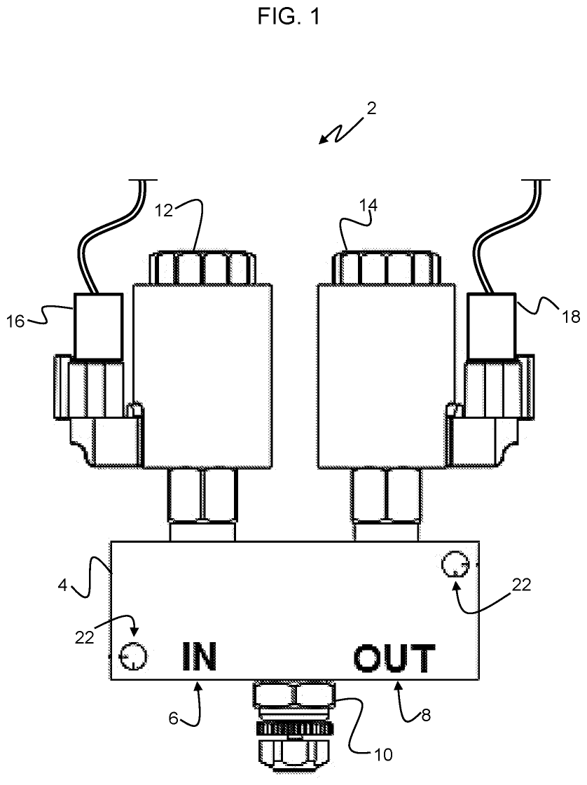

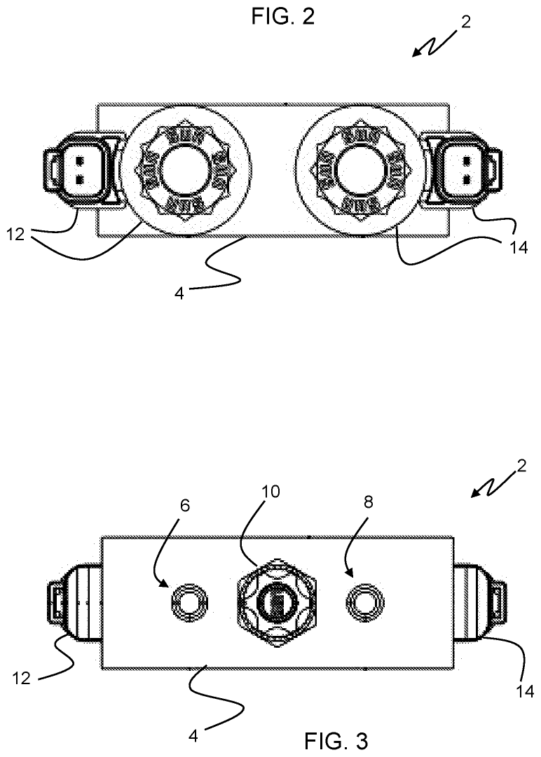

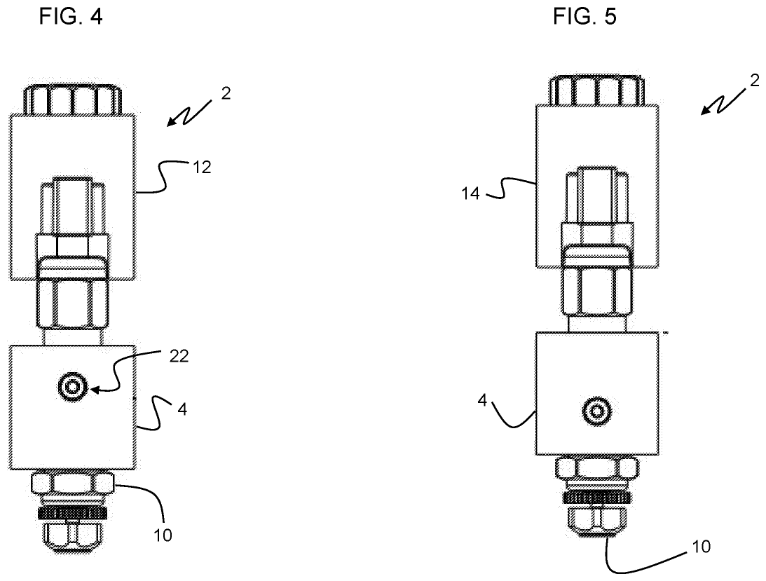

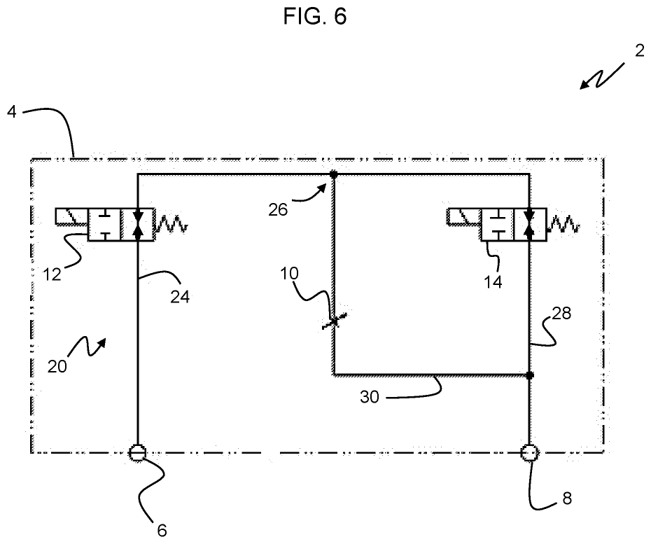

Turning now to FIGS. 1-7, a brief description concerning the various components of the present invention will now be briefly discussed. As can be seen in this embodiment, the launch control transmission brake 2 includes a block 4 with an input port 6 and an output port 8, a needle valve 10, an input directional valve 12, an output directional valve 14, an input electric harness 16 and an output electric harness 18.

The block 4 is preferably a solid piece of aluminum, with a fluid path 20 bored through the block 4, and mounting crevices 22 drilled in the outside of the block 4. The fluid path 20 runs from the input port 6, through the block 4 and out of the block 4 at the output port 8. The fluid path 20 has three portions: the input path 24—from the input port 6 to a branch 26; the output path 28—from the branch 26 to the output port 8; and the flow control path 30—from the branch 26 to the output port 8. The input directional valve 12 is positioned along the input path 24. The output directional valve 14 is positioned along the output path 28. The flow control path 30 leads to the needle valve 10 and then joins the output path 28 between the output directional valve 14 and the output port 8. The fluid path 20 is a through pathway from the input port 6 to the output port 8. The bore through the block defining the fluid path 20 is preferably substantially the same diameter as the hydraulic tubing 32 from the master cylinder 34 to the slave cylinder 36, so that installing the block 4 along the hydraulic path 32 of the clutch 38 does diminish the power, response or flow of the clutch system, or does not appreciably diminish the power, response or flow of the clutch system of a vehicle 40, such as an automobile, that the launch control transmission brake 2 is installed in.

In the embodiment shown, the input and output directional valves 12, 14 are 2-way normally open solenoid cartridge valves. When the input directional valve 12 is energized, input directional valve 12 closes off the input path 24, and prevents fluid flowing therethrough. This causes the clutch disc or clutch 38 to stay substantially exactly where it is in a level of engagement or contact with a flywheel, for example, when the input directional valve 12 is energized, and the clutch 38 will remain in the same level of engagement until the input directional valve 12 is de-energized. If the clutch 38 is fully disengaged—that is, no torque is transmitted from engine to transmission—the clutch 38 will stay fully disengaged if the input directional valve 12 is energized. If the clutch 38 is fully engaged—that is, all of the torque is transmitted from the engine to the transmission—the clutch 38 stays fully engaged if the input directional valve 12 is energized. If the clutch is 50% engaged, the clutch 38 stays at 50% engaged if the input directional valve 12 is energized. When the input directional valve 12 is de-energized, the input directional valve 12 returns to the normally open state, and input directional valve 12 no longer prevents fluid from flowing along the input path 24. When the output directional valve 14 is energized, the output directional valve 14 closes off the output path 28, and prevents fluid flowing therethrough. When the output directional valve 14 is de-energized, the output directional valve 14 returns to the normally open state, and the output directional valve 14 no longer prevents fluid from flowing along the output path 28. The needle valve 10 selectably sets a flow amount that may pass through the flow control path 30, especially when the output directional valve 14 is closed. The needle valve 10 may be 100% open and 0% closed, 0% open and 100% closed, or some range in between (2% open, 5% open, 10% open, 15% open, 25% open, etc.). The needle valve 10 slows fluid flow through the flow control path 30, but preferably still allows fluid through. The input and output directional valves 12, 14 could be, for example, poppet valves, spool valves, and could be cartridge valves, robust and preferred—as shown, or inline valves, that function to open and close the respective input path 24 and output path 28.

The input electrical harness 16 is connected to the input directional valve 12 to energize the input directional valve 12. The output electrical harness 18 is connected to the output directional valve 14 to energize the output directional valve 14. The wires 42 from the input electrical harness are connected to power 44 (e.g., from the automobile battery) and a first actuator 46, such as a button or switch on the steering wheel, dashboard, or stick shift, for example. The wires 42 from the output electrical harness 18 are connected to power 44 (e.g., from the automobile battery) and a second actuator 48, such as a button or switch on the steering wheel, dashboard, or stick shift, for example. Preferably polarity does not matter in hooking up the wires 42 of the input and the output electrical harnesses 16, 18.

The launch control transmission brake 2 is connected along the clutch fluid line 32, between the master cylinder 34 and the slave cylinder 36. The input port 6 connecting to the line 32 leading to the master cylinder 34 and the output port 8 connecting to the line 32 leading to the slave cylinder 36.

According to one embodiment, to use the launch control transmission brake 2, the user approaches the starting position with a vehicle 40 and actuates the output directional valve 14 with the second actuator 48 (preferably by flipping a switch on the dashboard and “arming the system”), thereby blocking fluid flow through the output path 28, but allowing needle valve 10 restricted fluid flow through the flow control path 30. The user then removes his/her feet from the gas and brake pedals, and presses the clutch pedal 50 past full clutch 38 disengagement. The user then starts to let up on the clutch pedal 50 until the clutch plate 38 first starts to slip-engage sufficient to just start to move the automobile 40 forward/or to just inch forward (0.1 mph, for example). Next, the user actuates the input directional valve 12 with the first actuator 46 (preferably by depressing and/or holding a button on the shift stick), thereby blocking fluid flow through the input path 24, and preventing any fluid from moving through the fluid path 20. In another embodiment, the user will press the clutch pedal 50 slightly down (2-5% of total pedal path, for example) after the automobile 40 first begins to inch forward, to achieve a point where the clutch is slip-engaged just shy of the point of moving the automobile, and then will actuate the first actuator 46. Actuating the first actuator 46 will hold the clutch 38 at the same state of engagement even if the user takes his/her foot fully off of the clutch pedal 50. The user will then place a foot on the brake pedal, stopping the automobile 40 from moving forward. If the user needs to inch forward during the launching process, and the user had slip-engaged the clutch 38 to the point of just moving the automobile 40 before actuating the first actuator 46, the user can just take his/her foot off the brake pedal, and let the partially engaged clutch 38 transfer part of the torque of the engine to the wheels and inch the automobile forward. If the user had slip-engaged the clutch 38 just shy of the point of moving the automobile 40 before actuating the first actuator 46, the user can then just toggle the first actuator back off and then back on quickly, allowing a small amount of fluid to pass through the input path and flow control path, and slightly engage the clutch 38 a bit more. The user can then just take his/her foot off the brake pedal, and let the partially engaged clutch 38 transfer part of the torque of the engine to the wheels through the partially engaged clutch 38 and inch the automobile 40 forward. When a desired displacement or distance traveled is met, the user just depresses the brake pedal again and stops the automobile 40.

When the time arrives to launch the automobile 40 off of the starting line, the user can just take his/her foot off of the brake pedal and apply gas and the automobile starts forward. The clutch 38 is already partially engaged. The user can then release/disengage the first actuator 46, thereby de-energizing the input directional valve 12, and opening the input path 24 in the block 4, allowing clutch fluid to flow through from the master cylinder 34, through the hydraulic tubing 32, into the input path 24, past the branch 26, through the flow control path 30 past the needle valve 10, to the output path 28, to the slave cylinder 36, causing the clutch 38 to engage further at a controlled and measured rate. This allows the clutch 38 to become fully engaged, at a controlled rate, as the user is accelerating the automobile 40 off the line. This helps prevent a torque spike, as the clutch 38 is already partially engaged, and the rate of approaching full engagement is proceeds at a controlled value. In a related alternative embodiment, the user can release the first actuator 46 and the brake pedal at the same time.

Then, at some point at or before the user wants to shift to second gear, the user will disengage (“disarm”) the second actuator 48, thereby de-energizing the output directional valve 14, and opening the output flow path 28 in the block 4. With the first actuator 46 already disengaged, the fluid path 20 would now be completely free flowing from input port 6 to output port 8. This allows the user to freely depress the clutch pedal 50, and freely force fluid from the master cylinder 34, through the fluid path 20, to the slave cylinder 36 and disengage the clutch 38, to allow a gear shift for the automobile 40.

In other embodiments, a vehicle computer ECU 52 having a computer memory, and ECU input, such as sensors 54 and a touch screen monitor 56, with electrical and/or data connections 58 to one or more of the components of the launch control transmission brake 2 system can be programed to automate one of the engagement and disengagement, or both, of one of the input directional valve 12, the output directional valve 14, the needle valve 10, input directional valve 12 and the output directional valve 14, the input directional valve 12 and the needle valve 10, the output directional valve 14 and the needle valve 10, or all three of the input directional valve 12, the output directional valve 14, and the needle valve 10. The output directional valve 14 can be programed to automatically disengage at a certain speed, such as 10 mph or 20 mph for example, or after a certain distance traveled from the start of motion, such as 50 feet or 100 feet for example, or if a certain RPM is reached, such as above a redline or above 6,500, 7,000, or 7,700 RPM, for example. In some embodiments, the ECU would check that the first actuator 46 has been released/disengaged before allowing the output directional valve 14 to be automatically released. In other embodiments, when the clutch pedal 50 is just starting to be depressed (such as the first half inch, inch, or two inches travel distance of the clutch pedal 50 path or first 1% of travel distance of the clutch pedal 50 path, for example) after the first actuator 46 has been released, the ECU 52 would automatically disengage the second actuator 48 and/or the output directional valve 14. In other embodiments, instead of fully opening the input directional valve 12 upon disengagement of the first actuator 46, the input directional valve 12 can be programed to pulse open and closed at a rate of one pulse per 2/10 a second, for example, allowing the clutch plate 38 to more smoothly progress from partial to full engagement with the flywheel/drive shaft, rather than all at once. The automobile ECU 52 may use milli amps converted from volts to control the pulsing of the input directional valve 12. The user could preferably set the number of pulses and the length of pulses, and the length of time between each pulse, for example. In some embodiments, the pulse could be achieved by a relay 60 along the input electrical harness 16, preferably with a capacitor to store energy. The ECU may be connected to the various components of the launch control transmission brake 2 system via a BUS. In some embodiments the ECU is attached to the block 4, directly or indirectly. In some embodiments, the monitor is located in the cabin of the vehicle.

In other embodiments the input directional valve 12 is a spool valve, which preferably releases at a defined rate. Thus, whenever the input directional valve 12 is actuated, the spool valve 12 would close. And then whenever the spool valve 12 is de-actuated/de-energized, the spool valve 12 could unspool at a certain rate. The rate could be preset with a mobile device 74 program or app that interacts with the ECU 52/controller, via bluetooth, for example, through a communications module 76 electrically connected to the ECU 52. There would preferably be a curvature graph on the app of how the clutch slips out. The user can choose to have the clutch slip from point A to point B at a first certain rate and from point B to point C at a different rate if the user desired. Points A, B, and C could be automobile speeds, RPMs, distance traveled, for example. The app would then communicate the insturctions to the ECU and the ECU would monitor the various variables, such as automobile speed, clutch pressure, clutch slip, RPMs, distance traveled, e.g. via assorted sensors, for example, and control the directional valve(s) to achieve the programed results. In one embodiment, the spool valve 12 would unspool at a first rate while the clutch plate 38 is still slipping with respect to the drive shaft/fly wheel, and at a second faster rate when the clutch plate has stopped slipping with respect to the drive shaft/fly wheel. The spool valve 12 would preferably be a spool type of cartage solenoid. In some embodiments where the input directional valve 12 is controlled by the ECU, it is possible to remove the output directional valve 14, the output electrical harness 16, the needle valve 10, and the flow control path 30. Using the two directional valves 12, 14, and the needle valve 10 does provide for robustness for the device, and the tactile thrill of manually actuating the two directional valves 12, 14.

In further embodiments, the output directional valve 14 could be spring loaded and engaged manually before launch, and could be on a retainer or something similar. A retainer retaining button could be present to where when the user pressed it, it held until something happened. This would then basically engage the flow control until something happened to trip it and reset it, allowing fluid through the output path. Thus, the flow control could just have it to where, after being set, whenever the clutch comes all the way out, for example, a signal could be sent to trip the flow control retainer and un-flow control the launch control transmission brake 2, allowing fluid to flow freely through the output path 28.

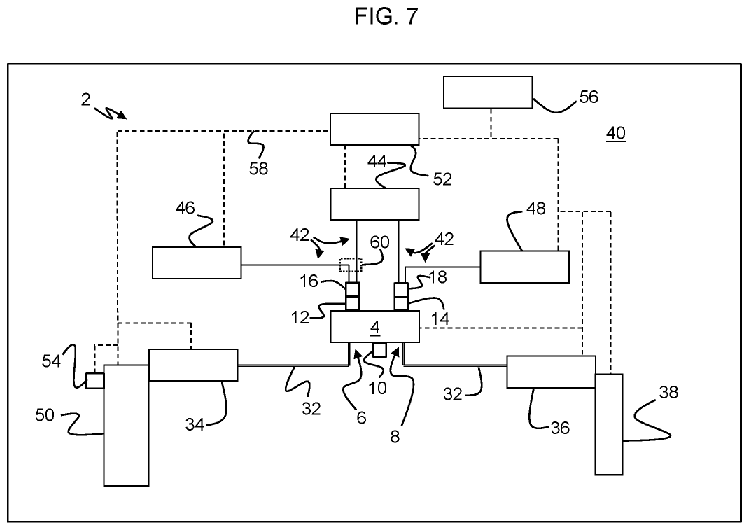

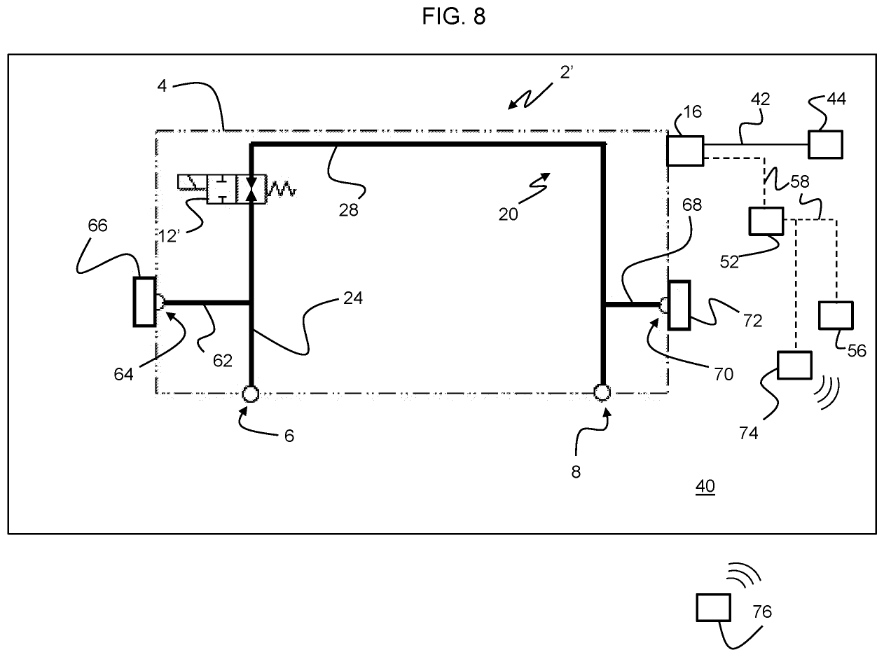

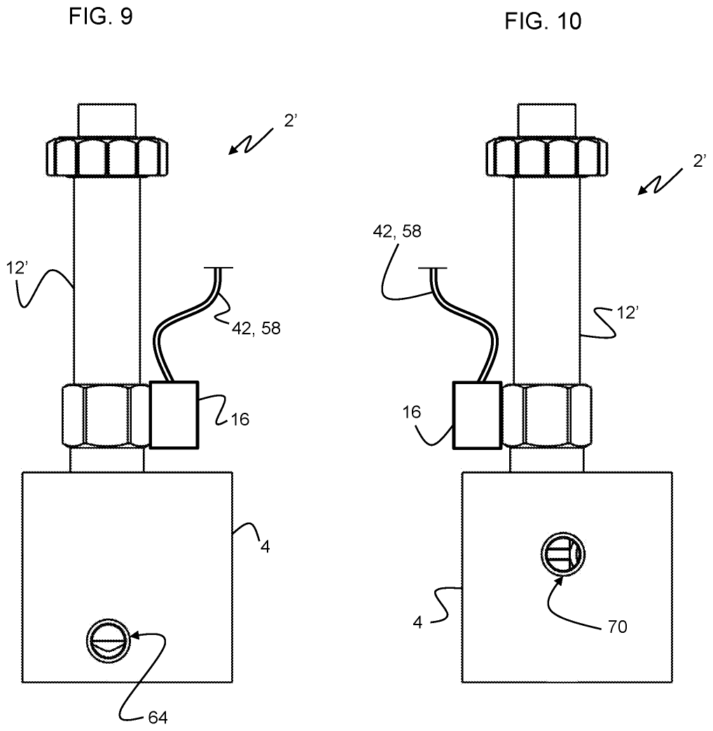

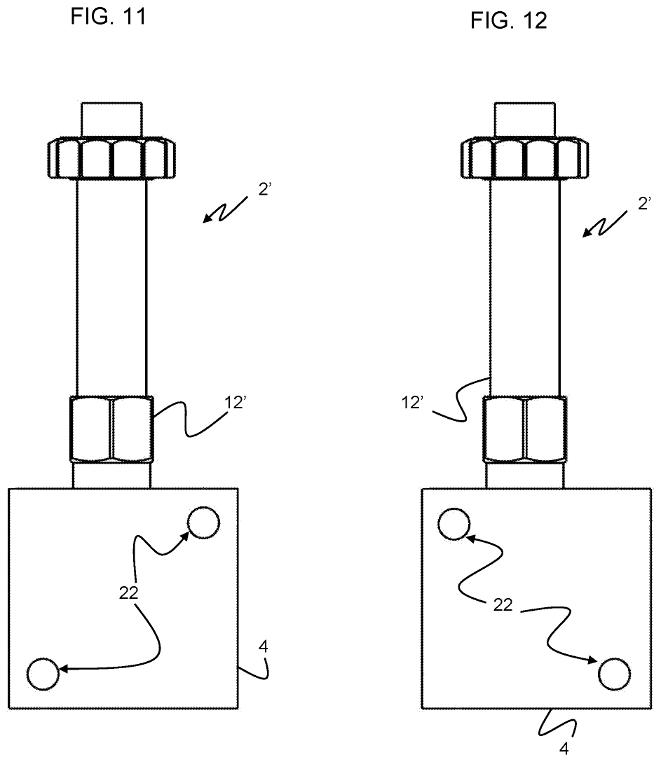

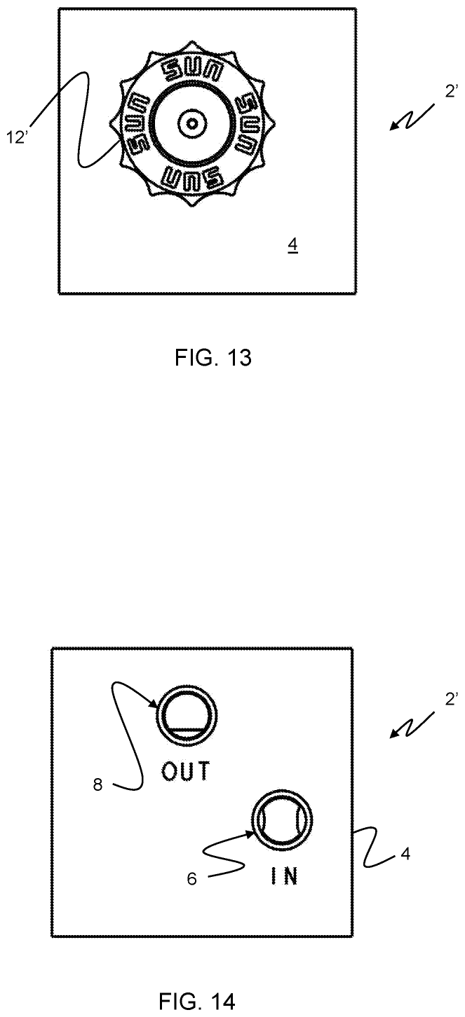

Turning now to FIGS. 8-14, a further embodiment of the launch control transmission brake 2′ is shown, utilizing a single valve 12′. In this single valve embodiment, the launch control transmission brake 2′ includes a block 4 with an input port 6 and an output port 8, an input directional valve 12′, and an input electric harness 16. The single valve launch control transmission brake 2′ may be installed in a substantially the same manner as the previous embodiment of the launch control transmission brake 2 is shown in FIG. 7, though with the single valve launch control transmission brake 2′ the input directional valve 12′ is controlled by the automobile ECU 52.

The single directional valve launch control transmission brake 2′ has a substantially square shaped body 4, with the input port 6 being fluidly connected to the master cylinder 34 and the output port 8 being fluidly connected to the slave cylinder. The input directional valve 12′ is preferably an electric proportional control valve 12′ mounted on a top face of the block 4, opposite the input port 6 and output port 8 on a bottom face. Going from the input port 6 to the output port 8, the fluid path 20 through the block 4 preferably traverses only a single directional valve, the input directional valve 12′. The input path 24 goes from the input port 6 to the input directional valve 12′. The output path 28 goes from the input directional valve 12′ to the output port 8. Branching off of the input path 24 is preferably a pressure sensor path 62 that leads to a pressure sensor port 64, upon which is mounted a pressure sensor 66. Branching from the output path 28 is preferably a clutch bleeder path 68 that leads to a clutch bleeder port 70, upon which is mounted a clutch bleeder valve 72. It is noted that the pressure sensor 66 and corresponding path 62 and port 64, and the clutch bleeder valve 72 and corresponding path 68 and port 70 may also be included in the two directional valve embodiment of the launch control transmission brake 2. The ports 6, 8, 64, 70 and the fluid path 20 are respectively preferably ⅛ inch npt threads bored into the block 4.

In this embodiment, the ECU 52 actuates the input directional valve 12′ based on programing that is imputed from the display/monitor/or other electronic input 56 or from a mobile device 74 of the user and stored in the ECU 52 memory. The launch control transmission brake 2 preferably includes a communication module 76 to facilitate remote communication between the ECU 52 and the display/monitor/or other electronic input 56 or from a mobile device 74, for example.

The communication module 76 of the illustrated example includes wired or wireless network interfaces to enable communication with external networks. The communication module 76 also includes hardware (e.g., processors, memory, storage, antenna, etc.) and software to control the wired or wireless network interfaces. In the illustrated example, the communication module 76 includes one or more communication controllers for cellular networks (e.g., Global System for Mobile Communications (GSM), Universal Mobile Telecommunications System (UMTS), Long Term Evolution (LTE), Code Division Multiple Access (CDMA)) and/or other standards-based networks (e.g., WiMAX (IEEE 802.16m); Near Field Communication (NFC), local area wireless network (including IEEE 802.11 a/b/g/n/ac or others), Wireless Gigabit (IEEE 802.11ad), etc.). In some examples, the communication module 76 includes a wired or wireless interface (e.g., an auxiliary port, a Universal Serial Bus (USB) port, a Bluetooth® wireless node, etc.) to communicatively couple with a mobile device 74 (e.g., a smart phone, a wearable, a smart watch, a tablet, etc.). In such examples, the vehicle 40 may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

In one embodiment, the ECU 52, via the communication module 76 is linked to an app on smart phone mobile device 74. This allows the user to create a custom profile via the app that controls the proportional value 12′ accordingly, which controls the rate of fluid flow through the fluid path 20. Another embodiment could use a remote display or monitor 56 that is electrically or remotely connected to the ECU 52, and acts as a user interface for a program running on the ECU 52 that allows the user to manually make changes or select various parameters of how the proportional value 12′ functions to control the fluid flow through the fluid path 20 during the course of launching the vehicle 40 into motion.

According to one embodiment, the single directional valve launch control transmission brake 2′ functions by the fluid flowing in and out of block 2 via the input port 6 and output port 8. The input proportional valve 12′ is biased to be normally open in an un-actuated/un-energized state, so that fluid may travel in and out of the block 4, and so the clutch pedal 50 and clutch 38 assembly operate as they normally would when the input proportional valve 12′ is unactuated. When a first actuator (such as a button) is actuated, the first actuator either wired or wirelessly transmits the actuation status data of the button 46 to the ECU 52. When the ECU 52 detects that the first actuator 46 was engaged, the ECU 52 arms the system 2 and actuates the input proportional valve 12′ to close the fluid path 20. When the button is released/the first actuator 46 is un-actuated, the ECU 52 commands the input proportional valve 12′ to partially open a specified amount to allow fluid to flow back through the block 4 fluid path 20 at a specified rate, coming in the direction from the slave cylinder 36, through the block 4 fluid path 20 to the master cylinder 34, and thus allowing the clutch 38 to progress in engagement to the drive. The value flow rate is valued by % from 0% to 100%, with 0% being all the way closed/the input proportional valve 12′ being fully actuated and 100% is all the way open/the input proportional valve 12′ being in its un-energized biased open state. The input proportional valve 12′ may be programed to stop mid disengagement and hold for certain periods of time while the running a launch program.

The clutch bleeder valve 72 allows the user to bleed the clutch in a remote location prior to the install of the launch control transmission brake 2, or any time after that, allowing all the air to be evacuated out of the clutch lines 32 in the clutch system.

The pressure sensor 66 reports the clutch fluid pressure by psi, for example, which allows the user to know how to use and set the launch control transmission brake 2 properly before launching, with the pressure ranging from 0-150 psi, for example.

Other valves may be used for the input directional valve 12, 12′ and output directional valve 14 in both the single directional valve embodiment of the launch control transmission brake 2′ and the two directional valve embodiment of the launch control transmission brake 2, including servo valves for example, and other valves that would be obvious to those in the art based on the contained disclosure.

The communication module 76 of the illustrated example includes wired or wireless network interfaces to enable communication with external networks. The communication module 76 also includes hardware (e.g., processors, memory, storage, antenna, etc.) and software to control the wired or wireless network interfaces. In the illustrated example, the communication module 76 includes one or more communication controllers for wireless personal area network(s) (e.g., including area networks based on the IEEE 802.15 standard) and/or wireless local area network(s) (e.g., Wi-Fi networks and/or other area networks based on the IEEE 802.11 standard). For example, the communication module 76 is a short-range wireless module that includes the hardware and firmware to establish a connection with a mobile device and/or another short-range wireless module (e.g., a short-range communication module 820 of FIG. 8) that is located nearby. In some examples, the short-range wireless module implements the Bluetooth® and/or Bluetooth Low Energy (BLE) protocols. The Bluetooth® and BLE protocols are set forth in Volume 6 of the Bluetooth® Specification 4.0 (and subsequent revisions) maintained by the Bluetooth® Special Interest Group.

Some or all of the operations described herein can be representative of an algorithm that corresponds to processor-executable instructions that may be stored, for example, in main or auxiliary or remote memory, and executed, for example, by an on-board or remote ECU 52, central processing unit (CPU), control logic circuit, or other module or device, to perform any or all of the above and/or below described functions associated with the disclosed concepts. It should also be recognized that the order of execution of the disclosed processes may be changed, additional steps may be added, and/or some of the steps described may be modified, eliminated, or combined.

Aspects of this disclosure may be implemented, in some embodiments, through a computer-executable program of instructions, such as program modules, generally referred to as software applications or application programs executed by an on-board vehicle computer. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in other manners (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore, I claim:

1. A launch control transmission brake comprising:
a block;
an input port and an output port defined in the block;
a fluid path connecting the input port and the output port;
an electrically actuated valve along the fluid flow path that closes the fluid path when the electrically actuated valve is actuated;
an input path being the flow path between the input port and the electrically actuated valve;
an output path being the flow path between the output port and the electrically actuated valve; and
an actuator that actuate the electrically actuated valve.

2. The launch control transmission brake of claim 1 further comprising a pressure sensor path leading from a pressure sensor port defined in the block to the input path, and a pressure sensor mounted on the pressure sensor port.

3. The launch control transmission brake of claim 1, further comprising a clutch bleeder path leading from a clutch bleeder port defined in the block to the output path, and a clutch bleeder valve mounted on the clutch bleeder port.

4. The launch control transmission brake of claim 1 further comprising an Electronic Control Unit (ECU) that is electrically connected to the electrically actuated valve and actuates and de-actuates the electrically actuated valve to achieve proper launch control transmission brake performance.

5. The launch control transmission brake of claim 4 further comprising a communication module electrically connected to the ECU that can receive wireless communications.

6. The launch control transmission brake of claim 4 further comprising a monitor electrically connected to the ECU that displays a status of the launch control transmission brake functioning, and receives a user's instruction.

7. The launch control transmission brake of claim 4, wherein the ECU has instructions stored on an ECU memory, the instructions when executed by a processor of the ECU causes the processor to
in a first step, actuate the electrically actuated valve and close the fluid flow path when a vehicle the launch control transmission brake is installed in is at a standstill and a clutch disc is slip-engaged with a flywheel, locking the clutch disc in a current state of engagement with the flywheel; and
in a second step, un-actuate the electrically actuated valve to a degree that allows the fluid flow path to partially open, and causing the clutch disc to move into further engagement with they flywheel.

8. The launch control transmission brake of claim 7, wherein the instructions stored on the ECU memory when executed by the processor of the ECU further causes processor to, in a third step, fully un-actuate the electrically actuated valve when the clutch disc becomes fully engaged with the flywheel, where engagement is a function of one of comparative rotational speeds of the flywheel and the clutch disc and torque transfer between the flywheel and the clutch.

9. The launch control transmission brake of claim 8, wherein the ECU initiates the first step in response to a signal from one of display mounted to the vehicle and a mobile device.

10. A launch control transmission brake comprising:
a block;
an input port and an output port defined in the block;
a fluid path connecting the input port and the output port defined in the block;
an input electrically actuated valve along an input path of the fluid flow path;
an output electrically actuated valve along an output path of fluid flow path between the input electrically actuated valve and the output port; and
a needle valve along a flow control path of the fluid flow path, the flow control path connecting at a first end where the input path meets the output path, and connecting at a second end to the output path between the output electrically actuated valve and the output port.

11. The launch control transmission brake of claim 10 further comprising an input electrical harness electrically connecting the input electrically actuated valve to power and a first actuator; and an output electrical harness electrically connecting the output electrically actuated valve to power and a second actuator.

12. The launch control transmission brake of claim 11 further comprising hydraulic tubing connecting the input port to a master cylinder, and additional hydraulic tubing connecting the output port to a slave cylinder.

13. The launch control transmission brake of claim 12 wherein the first actuator is one of a button and a switch mounted on one of a steering wheel, a dashboard and stick shift, and the second actuator is one of a button and a switch mounted on one of the steering wheel, the dashboard and the stick shift.

14. The launch control transmission brake of claim 13 wherein the first and the second actuator not both mounted on a same one of the steering wheel, the dashboard and the stick shift, and the stick shift.

15. The launch control transmission brake of claim 13 further comprising a relay electrically connected to the input electrical harness.

16. The launch control transmission brake of claim 13 wherein the input electrically actuated valve and the output electrically actuated valve are both 2-way normally open solenoid cartridge valves.

17. The launch control transmission brake of claim 13 wherein the input electrically actuated valve is a normally open spool type cartage solenoid.

18. The launch control transmission brake of claim 10 further comprising a pressure sensor path leading from a pressure sensor port defined in the block to the input path, and a pressure sensor mounted on the pressure sensor port, and a clutch bleeder path leading from a clutch bleeder port defined in the block to the output path, and a clutch bleeder valve mounted on the clutch bleeder port.

19. The launch control transmission brake of claim 12 further comprising an Electronic Control Unit (ECU) that is electrically connected to the input electrical harness and the output electrical harness, a communication module electrically connected to the ECU that can send and receive wireless communications,
wherein the ECU has instructions stored on an ECU memory, the instructions when executed by a processor of the ECU causes the processor to
in a first step, actuate the output electrically actuated valve and close the output path when a vehicle in which the launch control transmission brake is installed in is at a standstill,
in a second step, when a clutch disc is moved to be slip-engaged with a flywheel, actuating the input electrically actuated valve, locking the clutch disc in a current state of engagement with the flywheel;
in a third step, when the user
first, fully releases a brake pedal that was depressed more than 25% of a brake pedal path, and
second, depresses a gas pedal more than 50% of a gas pedal path,
fully un-actuate the input electrically actuated valve, causing the clutch disc to move into further engagement with they flywheel at a controlled rate; and
in a fourth step, when the user then depresses a clutch pedal more than 5% of a clutch pedal path, fully un-actuate the output electrically actuated valve.

20. A launch control transmission brake comprising:
a block;
an input port and an output port defined in the block;
a fluid path connecting the input port and the output port defined in the block;
an input electrically actuated valve along an input path of the fluid flow path;
an output electrically actuated valve along an output path of fluid flow path between the input electrically actuated valve and the output port;
a needle valve along a flow control path of the fluid flow path, the flow control path connecting at a first end where the input path meets the output path, and connecting at a second end to the output path between the output electrically actuated valve and the output port;
an input electrical harness electrically connecting the input electrically actuated valve to power and a first actuator;
an output electrical harness electrically connecting the output electrically actuated valve to power and a second actuator;
hydraulic tubing connecting the input port to a master cylinder, and additional hydraulic tubing connecting the output port to a slave cylinder;
the first actuator being one of a button and a switch mounted on one of a steering wheel, a dashboard and stick shift;
the second actuator being one of a button and a switch mounted on one of the steering wheel, the dashboard and the stick shift;
the first and the second actuator not both mounted on a same one of the steering wheel, the dashboard and the stick shift, and the stick shift;
a relay electrically connected to the input electrical harness;
the input electrically actuated valve and the output electrically actuated valve are both 2-way normally open solenoid cartridge valves;
a pressure sensor path leading from a pressure sensor port defined in the block to the input path, and a pressure sensor mounted on the pressure sensor port; and
a clutch bleeder path leading from a clutch bleeder port defined in the block to the output path, and a clutch bleeder valve mounted on the clutch bleeder port.
